(19) United States
(12) Patent Application Publication
(10) Pub. No.: US 2008/0270021 A1
(43) Pub. Date: Oct. 30, 2008

(54) Drive information collecting apparatus

(75) Inventor: Kazunao Yamada, Anjo-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/148,663

(22) Filed: Apr. 21, 2008

(30) Foreign Application Priority Data
Apr. 25, 2007 (JP) 2007-115571

(51) Int. Cl. G01C 21/00

(52) U.S. Cl. 701/201

(57) ABSTRACT

A drive information collecting apparatus includes position specifying portion, storage control portion, and statistical confidence level storage portion. The position specifying portion specifies a present position of a vehicle and a road section. The storage control portion causes a storage medium to store a drive information item of each of the road section. The drive information item is collected while the vehicle travels. The statistical confidence level storage portion specifies a statistical confidence level based on a divergence between a predetermined reference value and the collected drive information item. The statistical confidence level indicates a degree of variation of the collected drive information item. The statistical confidence level storage portion associates the collected drive information item with the statistical confidence level and causes the storage medium to store the collected drive information item.

### CROSS REFERENCE TO RELATED APPLICATION

This application is based on and incorporates herein by reference Japanese Patent Application No. 2007-115571 filed on Apr. 25, 2007.

### BACKGROUND OF THE INVENTION

1. Field of the Invention

The present invention is related to a drive information collecting apparatus that specifies a road section, on which a target vehicle travels, and that causes a storage medium to store drive information item for each road section. In the above, the target vehicle may be, for example, an own vehicle, on which the drive information collecting apparatus is mounted, and the information item has been collected while the target vehicle travels.

2. Description of Related Art

Conventionally, for example, JP 3022115 has described an apparatus that stores road information, which has been collected using various sensors mounted on the vehicle while the vehicle travels, in database. Then, the apparatus determines optimal control target values for an on-board control system of the vehicle based on the road information stored in the database such that the drivability, cost effectiveness, and safety for a drive are improved.

Because the apparatus described in JP 3022115 is configure to collect general road shape information items, such as an elevation, a gradient, a degree of curve, for determination of the control target values of the on-board control system, it is possible to accurately control the on-board control system. However, for example, in a case, where the apparatus is configured to collect a vehicle information item, such as a vehicle speed, an electric power consumption, fuel consumption, and to determine the control target values of the on-board control system using the above vehicle information items, it may not possible to accurately control the on-board control system, disadvantageously. This disadvantage may occur because the above vehicle information items are easily influenced by a traffic flow.

### SUMMARY OF THE INVENTION

The present invention is made in view of the above disadvantages. Thus, it is an objective of the present invention to address at least one of the above disadvantages.

According to one aspect of the present invention, a drive information collecting apparatus for a vehicle includes position specifying means, storage control means, and statistical confidence level storage means. The position specifying means specifies a present position of the vehicle and a road section, on which the vehicle travels. The storage control means causes a storage medium to store a drive information item of each of the road section. The drive information item is collected while the vehicle travels. The statistical confidence level storage means specifies a statistical confidence level based on a divergence between a predetermined reference value and the collected drive information item. The statistical confidence level indicates a degree of variation of the collected drive information item. The statistical confidence level storage means associates the collected drive information item with the statistical confidence level and causes the storage medium to store the collected drive information item.

According to another aspect of the present invention, A drive information collecting apparatus for a vehicle includes position specifying means, storage control means, and statistical confidence level storage means. The position specifying means specifies a present position of the vehicle and a road section, on which the vehicle travels. The storage control means causes a storage medium to store a drive information item of each of the road section. The drive information item is collected while the vehicle travels. The statistical confidence level storage means specifies a statistical confidence level based on a divergence between a predetermined reference value and the collected drive information item. The statistical confidence level storage means associates the collected drive information item with the statistical confidence level and causes the storage medium to store the collected drive information item.

### BRIEF DESCRIPTION OF THE DRAWINGS

The invention, together with additional objectives, features and advantages thereof, will be best understood from the following description, the appended claims and the accompanying drawings in which:

FIG. 1 is a diagram illustrating a drive information collecting apparatus according to one embodiment of the present invention;

FIG. 2A is a diagram for explaining links in road map information;

FIG. 2B is a diagram for explaining supplement shape points in the road map information;

FIG. 3 is a diagram for explaining processing for an information center and the drive information collecting apparatus;

FIG. 4 is a diagram for explaining statistical processing by the information center;

FIG. 5 is a diagram illustrating classification information;

FIG. 6 is a diagram illustrating a configuration of a learning database;

FIG. 7 is a flow chart of a control portion of the drive information collecting apparatus; and

FIGS. 8A and 8B are diagrams for explaining data filing procedure for storing data items in the learning database.

### DETAILED DESCRIPTION OF PREFERRED EMBODIMENTS

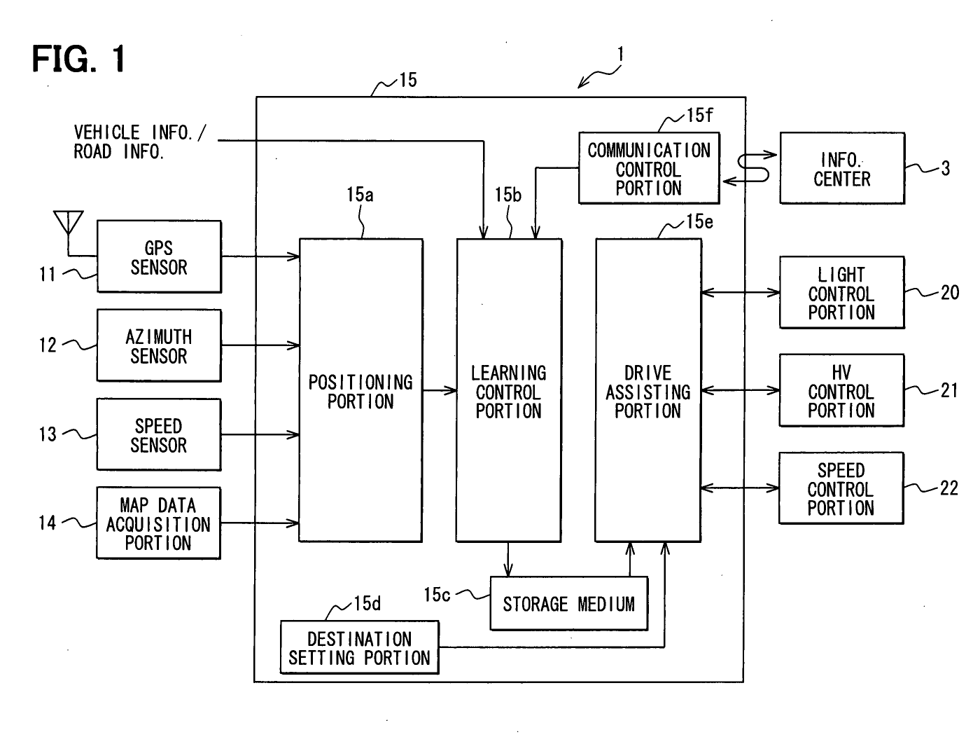

FIG. 1 shows a configuration of a drive information collecting apparatus according to one embodiment of the present invention. A drive information collecting apparatus 1 is configured to serves as a navigation device mounted on a vehicle or a target vehicle. Note that, the vehicle is a hybrid vehicle and is mounted with a light control portion 20, a hybrid vehicle (HV) control portion 21, and a vehicle speed control portion 22. The HV control portion 21 controls a charging and assist control of the hybrid vehicle. The light control portion 20 changes a direction of a headlight in accordance with a vehicle speed and with a road shape of the road ahead of the vehicle. The vehicle speed control portion 22 controls the vehicle speed in accordance with the road shape ahead of the vehicle.

The drive information collecting apparatus 1 includes a GPS sensor 11, an azimuth sensor 12, a speed sensor 13, a map data acquisition portion 14, and a control portion 15.

The GPS sensor 11 receives signals from GPS satellites and transmits to the control portion 15 information for specifying a present position of the target vehicle. The information includes precision information or a level or accuracy, such as Horizontal Dilution Precision (HDOP), that indicates deterioration of precision in a horizontal direction due to distribution of the GPS satellites.

The azimuth sensor 12 transmits to the control portion 15 a signal, which indicates an amount of change in azimuth of the target vehicle.

The speed sensor 13 transmits a vehicle speed signal based on the vehicle speed of the target vehicle to the control portion 15.

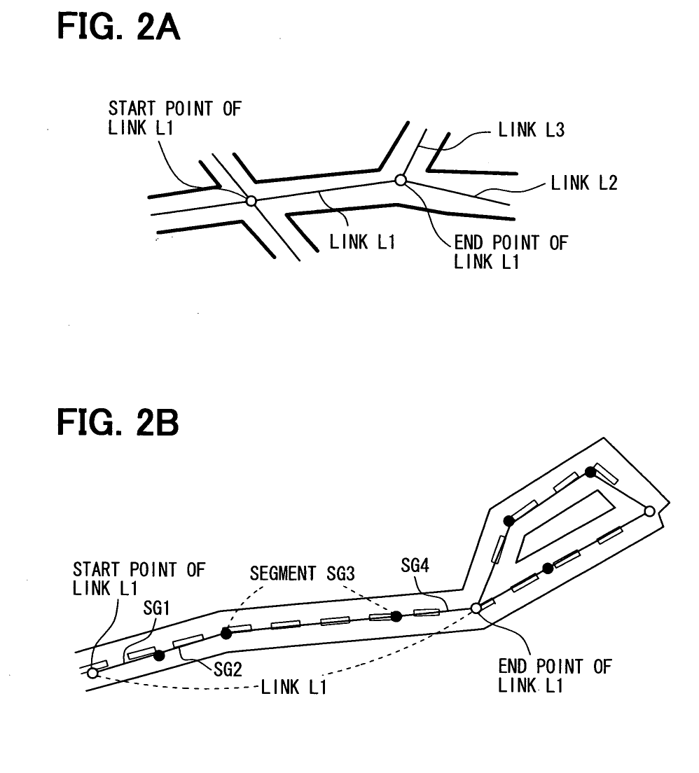

The map data acquisition portion 14 acquires map data from a map database that stores map data of an associated country or associated region. The above map data includes the road map information. As shown in FIG. 2A, the road map information includes a link information item that indicates a link for connecting intersections. Note that, a center position of the intersection corresponds to a start point of the link and an end point of the link. Also, the link information item includes road identification (link ID) and road type information, such as a highway, an ordinary road, and a narrow street. Also, the road map information includes supplement shape points that is associated with the road shape of a road that corresponds to each link, and a minimum unit of the road defined by the supplement shape points is referred as a segment. For example, in FIG. 2B, the supplement shape points are indicated by black dots, and the road shape of the road corresponding to the link L1 is indicated by segments SG1 to SG4.

The control portion 15 includes a positioning portion 15a, a learning control portion 15b, a storage medium 15c, a destination setting portion 15d, a drive assisting portion 15e, and a communication control portion 15f.

The positioning portion 15a acquires a relative position of the target vehicle based on signals inputted from the azimuth sensor 12 and the speed sensor 13. Also, the positioning portion 15a acquires an absolute position of the target vehicle computed based on the information inputted from the GPS sensor 11. Then, the positioning portion 15a specifies a target vehicle position using the relative position and the absolute position of the target vehicle. Further, a map matching technique is employed such that the road identification (link ID) and the road type of the road section, on which the target vehicle travels, are specified. The present position of the target vehicle is finally determined by correcting the target vehicle position to correspond to the position on the above road.

Also, the positioning portion 15a specifies a position confidence level that indicates a precision of the present position of the target vehicle relative to the precision information, such as HDOP, included in the information inputted from the GPS sensor 11. Note that, the position confidence level of the present embodiment indicates a larger value when the precision of the present position is high, and indicates a smaller value when the precision of the present position is low.

The learning control portion 15b associates the drive information item of the road section, on which the target vehicle travels, with the road identification (link ID) and causes the storage medium 15c to store the drive information item. The drive information item is collected by each sensor mounted on the target vehicle. The road identification is transmitted by the positioning portion 15a and indicates the road section, on which the target vehicle travels. Also, when the storage medium 15c stores past drive information item, an average value of the drive information item is computed in accordance with a number of times of driving based on the collected drive information item and a past drive information item stored in the storage medium 15c. Then, the learning control portion 15b causes the storage medium 15c to store the above average value as a new drive information item. Note that, the drive information item includes vehicle information item and road information. Typically, the vehicle information item may be a vehicle speed, an electric power consumption, a fuel consumption, gear shift lever position information, accelerator pedal position information, an engine rotational speed, and the number of times of operating a brake. The road information may be a road gradient, and a road degree of curve, for example. Note that, in the present embodiment, the vehicle speed is computed based on the vehicle speed signal transmitted from the speed sensor 13, and the storage medium 15c is caused to store the above vehicle speed as the drive information item.

The storage medium 15c includes a nonvolatile memory, such as a flash memory.

The destination setting portion 15d specifies a route from an origin to a destination in accordance with an operation of the user. Also, the destination setting portion 15d reports the drive assisting portion 15e about route information from the origin to the destination.

The drive assisting portion 15e transmits the vehicle information item stored in the storage medium 15c and the route information reported by the destination setting portion 15d in accordance with the on-board control devices, such as the light control portion 20, the HV control portion 21, and the vehicle speed control portion 22.

The control portion 15 is configured as a computer having a CPU, a ROM, a RAM, and an I/O, and the CPU executes various processing based on programs stored in the ROM. Note that, the positioning portion 15a, the learning control portion 15b, the destination setting portion 15d, and the drive assisting portion 15e are realized by the processing executed by the CPU of the control portion 15.

The communication control portion 15f is communicated with exterior through radio communication and is capable of being in two-way communication with an information center 3.

The information center 3 is configured to have a server that includes a database storing traffic flow information items. The traffic flow information items are collected while multiple probe vehicles travels and indicate a traffic flow of each road section.

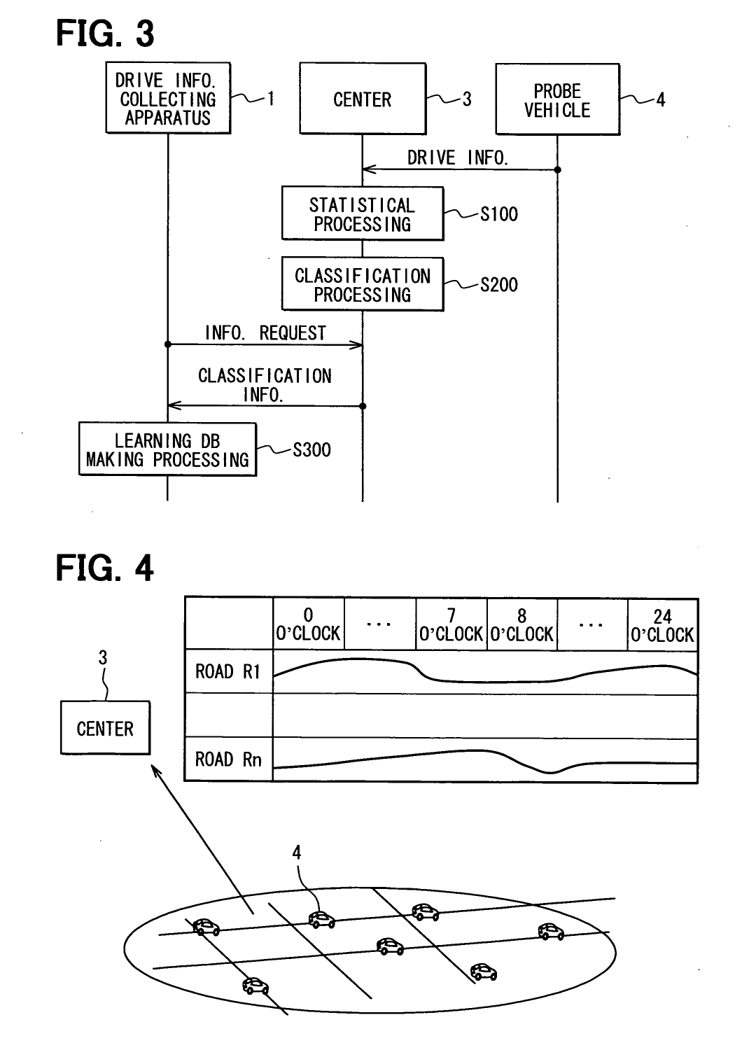

When the information center 3 receives the drive information items that are collected while the multiple probe vehicles 4 travel, the information center 3 performs statistical processing at S100 as shown in FIG. 3 and stores the drive information items in a database. Note that, the drive information item collected by the probe vehicle 4 include a vehicle speed for each link as the traffic flow information item. For example, the information center 3 receives the vehicle speeds from the multiple probe vehicles 4 and acquires an average trend of the vehicle speeds of the multiple probe vehicles 4 for each link (see FIG. 4). Then, the information center 3 computes an average vehicle speed for each link of a certain interval (for example, 10 minutes) based on the above average trend of the vehicle speeds and stores the computed average vehicle speed in the database.

Then, at S200, the information center 3 performs classification processing to the traffic flow information items stored in the database. The information center 3 generates classification information by classifying the drive information item in accordance with the characteristic of the traffic flow information item of each link stored in the database and stores the classification information in another region in the database. In the above, the classification information is designed to have multiple categories, such as a time zone, a day type.

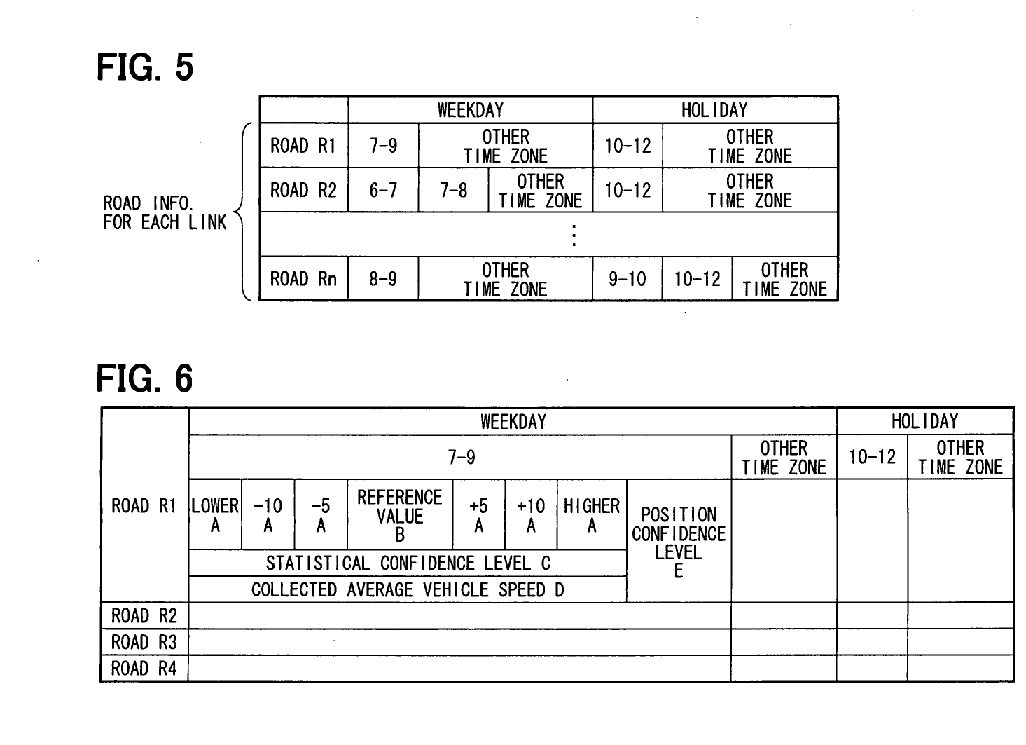

FIG. 5 shows an example of a configuration of the classification information. For example, in a case, where an average vehicle speed of the vehicles on a road R1 (link L1) is less than 20 km/h in a time zone from 7 o'clock to 9 o'clock, and where an average vehicle speed is equal to or greater than 20 km/h in the other time zone other than 7 o'clock to 9 o'clock, the classification information has two categories, such as a category of 7 o'clock to 9 o'clock and another category of other than 7 o'clock to 9 o'clock as shown in rows of the road R1 in FIG. 5. In the above, the other time zone other than 7 o'clock to 9 o'clock is a time zone from 9 o'clock to 7 o'clock or a combined time rage of (a) 0 o'clock to 7 o'clock and (b) 9 o'clock to 24 o'clock, for example. Similar to the above, the classification information has multiple categories determined in accordance with the characteristic of the average vehicle speed for each road Rn (link Ln). Further more, the classification information has categories of the day type. The day type or a type of day includes a weekday and a holiday and is determined in consideration of day of week, a feast day, etc.

When the drive information collecting apparatus 1 is firstly activated, or when a predetermined maintenance interval comes, the control portion 15 of the present embodiment acquires the classification information from the information center 3 as shown in FIG. 3. Then, the control portion 15 performs “learning database making processing” for making a learning database based on the classification information at S300. In the above, the learning database is made to have categories of the time zone based on the classification information.

FIG. 6 shows a configuration of the learning database. The learning database includes multiple filing parts. One of the filing parts files or stores a reference value B that is determined for each road type. Another filing part files the number of times of driving A and multiple filing parts are prepared in accordance with a degree of divergence or difference from the reference value B. The number of times of driving A may be referred as a drive count A. Another filing part files a statistical confidence level C. Still another filing part files a drive information item D, such as the average vehicle speed, collected while the target vehicle travels. Another filing part files a position confidence level E transmitted from the positioning portion 15a. Note that, the above filing parts for the drive count A are prepared correspondingly to intervals of 5 km relative to the reference value B.

The above filing parts A, B, C, D, E are categorized by the classification information generated by the information center 3 and, specifically, are categorized by a time zone and the day type.

In the present embodiment, the drive information item for each road section collected while the vehicle travels is classified by the categories of the learning database, and the learning database is updated using the drive information item.

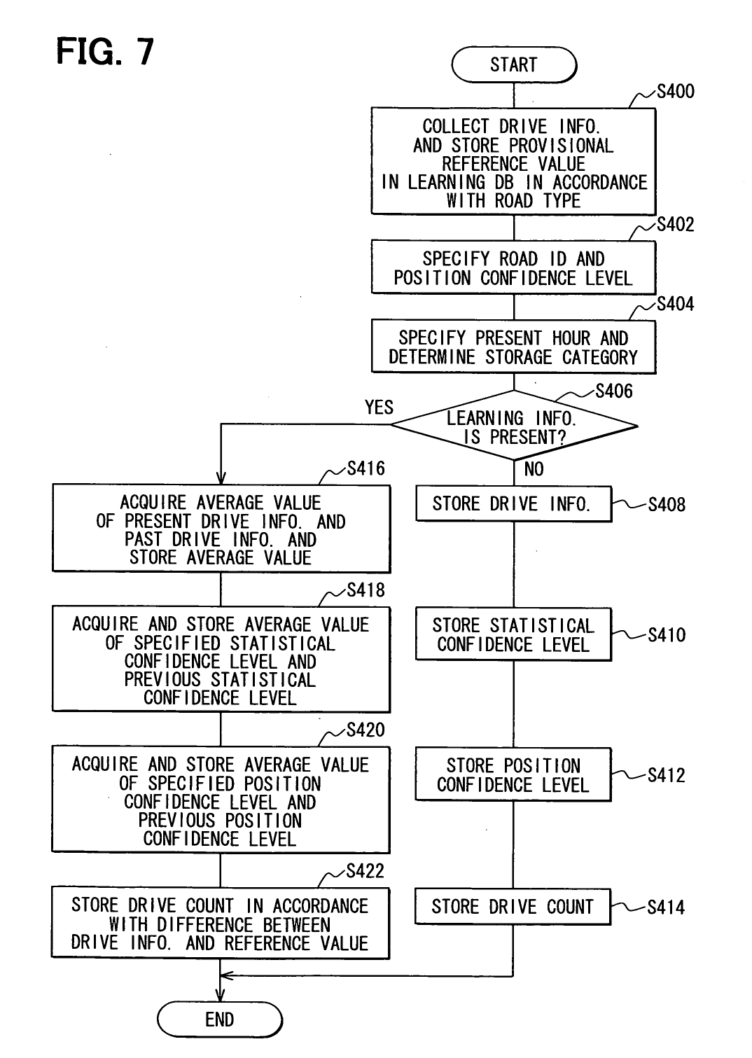

Then, by referring to the flowchart shown in FIG. 7, processing executed by the control portion 15 of the drive information collecting apparatus 1 is described. The control portion 15 executes the processing shown in FIG. 7 every time the target vehicle reaches a start point and an end point of a target link.

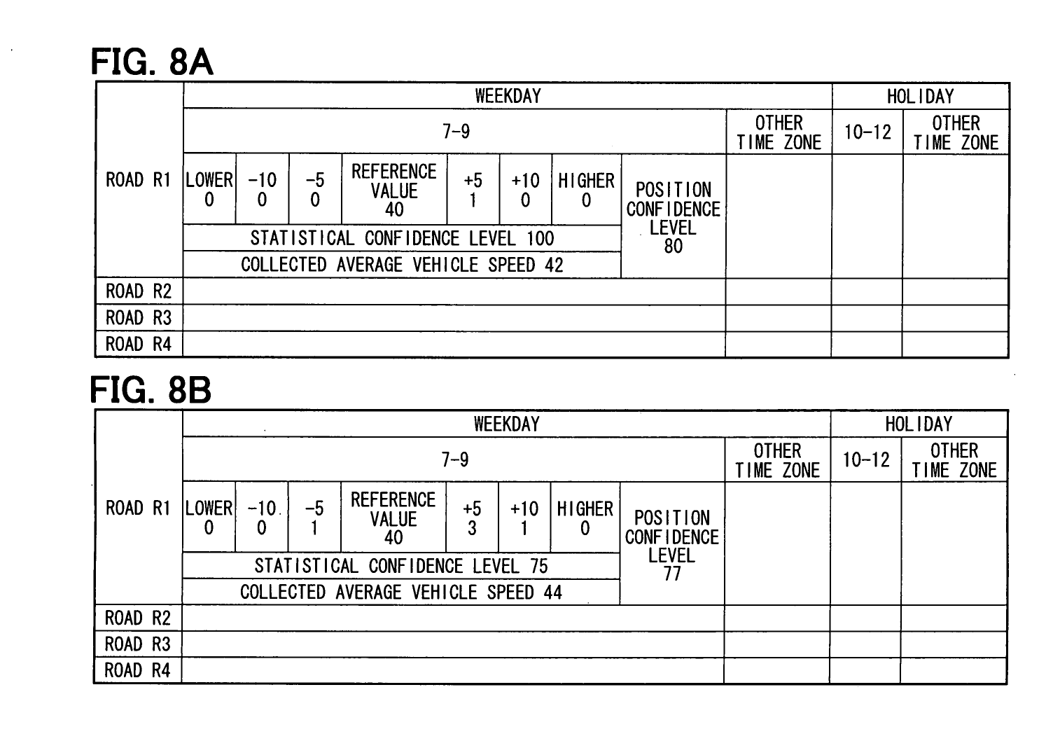

The drive information items are collected by using each sensor mounted on the target vehicle, and the learning database is caused to store a provisional reference value in accordance with the road type of the road that corresponds to the target link at S400. Specifically, as shown in FIG. 8A, the learning database is caused to store the reference value B (for example, 40 km/h), which value is predetermined correspondingly to the road type of the target link.

Then, the road identification (link ID) and the position confidence level of the target link are specified at S402. Note that, the positioning portion 15a specifies the position confidence level.

Then, a present time or a present hour is specified at S404 such that a storage category in the learning database is determined for storing the collected drive information item. For example, if the drive information item is collected at 7:30 on Monday, the storage category in the learning database is determined to be a category of 7 to 9 o'clock on weekday.

Then, it is determined whether learning information is present based on whether the drive information item has been stored in the storage category in the learning database at S406.

When any drive information item has not been stored in the storage category in the learning database, the determination at S406 indicates “NO”, and then, the collected drive information item stored in the storage category determined at S404 is stored at S408. For example, when the target link is the road R1 and an average vehicle speed of 42 km/h is collected as the drive information item, as shown in FIG. 8A, the average vehicle speed (42 km/h) is stored as the drive information item in the storage category determined at S404.

Next, the statistical confidence level is stored at S410. Specifically, in accordance with the divergence between the predetermined reference value and the collected drive information items, a statistical confidence level indicative of a degree of variation of the collected drive information items is specified. Then, the statistical confidence level is associated with the drive information items, and the filing part in the learning database for the statistical confidence level is caused to store the statistical confidence level. The statistical confidence level may be defined as a variation between (a) most frequently collected drive information items and (b) other drive information items instead of being defined as the divergence from the reference value. Specifically, when the drive information items in a range of “the reference value +5” are most frequently collected, the reference value +5 is defined as a reference, and thereby the variation among the collected drive information items is determined relative to the above defined reference.

The statistical confidence level of the present embodiment is indicated by numerals 0 to 100, and when the statistical confidence level is small, the variation of the drive information items is determined to be large. For example, when the statistical confidence level is specified as 100, 100 is stored in the filing part in the learning database for the statistical confidence level.

Then, the position confidence level is stored at S412. For example, when the positioning portion 15a specifies a position confidence level of “80”, “80” is associated with the collected drive information item and stored in the filing part in the learning database for the position confidence level.

Then, the drive count is stored at S414. For example, when an average vehicle speed of 42 km/h is collected once as the drive information item, the drive count of “1” is stored in the filing part of a range “the average vehicle speed 40 km/h+5 km/h”, and the present processing is ended.

As above, every time the target vehicle reaches the start point or the end point of the target link, the above processing is executed, and the drive information item is stored in the learning database.

When the target vehicle again travels on the road that corresponds to the certain link, the drive information item of which link has been stored in the learning database, the determination at S406 becomes YES, and then, processing is executed at S416 for acquiring an average of (a) the presently collected drive information item and (b) the past drive information item and for storing the average in the storage category determined at S404. Specifically, the average value of the drive information item in accordance with the drive count is acquired from (a) the presently collected drive information item and (b) the previously stored drive information item. Then, the average value is stored as a new drive information item in the corresponding filing part in the storage category determined at S404. As above, the average vehicle speed (44 km/h) is filed in the filing part for the drive information item in FIG. 8B.

Then, the statistical confidence level is specified, and processing is executed for acquiring the average of the specified statistical confidence level and the past statistical confidence level to store the average at S418. Similar to the case of the drive information, the average value of the statistical confidence level in accordance with the drive count is acquired from (a) the specified statistical confidence level and (b) the previously stored statistical confidence level. Then, the average value is stored as a new statistical confidence level in the corresponding filing part in the storage category, which is determined at S404. As above, “75” is filed in the filing part for the statistical confidence level in FIG. 8B.

Then, the position confidence level is stored at S420. Specifically, the average of the position confidence level specified by the positioning portion 15a and the previous position confidence level that has been stored is sequentially acquired and is stored in the filing part for the position confidence level as the new position confidence level. As above, “77” is filed in the filing part for the position confidence level in FIG. 8B.

Then, the drive count is stored at S422. For example, when the average vehicle speed of 48 km/h is collected as the drive information item, the drive count of “1” is stored in the filing part of a range “the average vehicle speed 40 km/h+10 km/h”, and then the processing is ended. As above, the drive count is stored in a corresponding filing part in accordance with the difference between the drive information item (e.g., 48 km/h) and the reference value (e.g., 40 km/h).

As above, the learning database is made to have multiple categories of the time zone in accordance with the characteristic of the traffic flow information item filed in the database of the information center 3. Also, the collected drive information item is classified by the above categories in the learning database, and the learning database is updated using the classified drive information item.

Each of the HV control portion 21, the light control portion 20, and the vehicle speed control portion 22 transmits to the drive information collecting apparatus 1 a request of transmission of the vehicle information item. Then, the above control portions 20, 21, 22 perform various controls by the control target values, which are determined based on the drive information item transmitted by the drive information collecting apparatus 1 in response to the request of transmission.

For example, the HV control portion 21 acquires a vehicle speed and a road gradient from the drive information collecting apparatus 1, the vehicle speed and the road gradient being associated with the route to the destination. Based on the above information items, a charging schedule for effectively reducing fuel consumption is generated. Then, based on the charging schedule, the hybrid vehicle is charged and assist control for the hybrid vehicle is performed.

Also, the light control portion 20 acquires from the drive information collecting apparatus 1 a road gradient and a road degree of curve of the road ahead of the vehicle, and the direction of the headlight is caused to be changed based on the above road shape information of the road ahead of the vehicle.

Also, the vehicle speed control portion 22 acquires the road gradient and the road degree of curve of the road ahead of the vehicle from the drive information collecting apparatus 1, and the vehicle speed control is executed for controlling the vehicle speed based on the above road shape information of the road ahead of the vehicle.

Also, because the drive information item is associated with the statistical confidence level and with the position confidence level and is stored in the learning database, each of the on-board control devices 20 to 22 is able to selectively use the drive information items having a high degree of accuracy based on the statistical confidence level and the position confidence level. The precision for controlling each portion of the vehicle is enabled to be improved.

According to the above configuration, in accordance with divergence between the predetermined reference value and the collected drive information item, the statistical confidence level is specified. Here, the statistical confidence level indicates the degree of variation of the collected drive information items. The collected drive information item is associated with the statistical confidence level and is stored in the storage medium. As a result, the collected drive information items are enabled to be more accurately managed. Thus, the on-board control device is enabled to recognize the degree of variation of the drive information items based on the statistical confidence level, and thereby is enabled to more accurately operate controls.

Also, the average of the statistical confidence level in accordance with the drive count is acquired based on the statistical confidence level of the collected drive information item and the statistical confidence level of the past drive information item stored in the storage medium, and the storage medium is caused to store the average as the new statistical confidence level.

Also, the position confidence level, which indicates the precision of the present position of the target vehicle, is specified. Then, the position confidence level is associated with the drive information item stored in the storage medium and is stored in the storage medium. Thus, the collected drive information item is enabled to be more accurately managed. As a result, the on-board control device is enabled to recognize the precision of the present position based on the position confidence level, and thereby, is enabled to more accurately perform controls.

Also, the average value of the position confidence level in accordance with the drive count is acquired from the position confidence level of the collected drive information item and the position confidence level of the past drive information item stored in the storage medium. Then, the above average value is stored in the storage medium as the new position confidence level.

Also, the learning database is made to have multiple categories of the time zone in accordance with the characteristic of the traffic flow information item stored in the database of the information center 3. Also, the collected drive information item is classified by the categories of the learning database, and the learning database is updated using the collected drive information item. As a result, the collected drive information items is enabled to be more accurately managed.

For example, in a case, where the collected drive information items are classified every one hour to be stored in the storage medium 15c, even if the traffic flow is bad in the first 30 minutes and is good in the last 30 minutes, the collected drive information item is classified in the same category of the hour. As a result, the collected drive information items may be difficult to be accurately managed correspondingly to the tendency or the state of the traffic flow. However, in the present embodiment, the collected drive information items are classified by the multiple time zones in accordance with the characteristic of the traffic flow information item to be stored in the storage medium. As a result, the collected drive information items are enabled to be more accurately managed. Note that, the drive information item stored in the storage medium is enabled to reflect a drive characteristic of the driver.

Note that, the present invention is not limited to the above embodiments. However, various embodiments are able to be practiced based on the scope of the present invention.

For example, in the above embodiments, the link serves as the road section, and the drive information items are collected for each link to be stored in the storage medium. However, the road section is not limited to the link, for example, and the drive information items may be collected for each segment and may be stored in the storage medium.

Also, in the above embodiments, the learning database is made to have the categories of the time zones, in addition to the categories of the day type. Then, the collected drive information items are classified by the above categories of the above learning database. However, the learning database may be alternatively made to have solely the categories of time zone exclusively of the day type.

Also, each of the above embodiments is configure such that the drive information item includes the traffic flow information item, which corresponds to the average vehicle speed of the vehicle passing the link. Then, the classification information is generated to have multiple categories of the time zone, which categories are determined in accordance with the characteristic of the above average vehicle speed. However, for example, the drive information item may alternatively include a link travel time as the traffic flow information item. The link travel time indicates a time required for the vehicle to pass through the link. Then, alternative classification information may be generated to have the categories of time zone, which categories are determined in accordance with the characteristic of the link travel time.

Also, in the above embodiments, as shown in FIG. 5, the category of 7 o'clock to 9 o'clock and the category of 9 o'clock to 7 o'clock are defined using a unit of one hour. However, the definition is not limited to the above. For example, the category may be defined using a unit of shorter period, such as a category of 7:10 to 8:50 and the other category other than 7:10 to 8:50. The above other category other than 7:10 to 8:50 is a combination of a category of 0:00 to 7:10 and a category of 8:50 to 24:00, for example. As above, by defining the category using the shorter period, the drive information items are enabled to be more accurately managed.

Also, in the above embodiments, the drive information items are classified into two levels, such as a category of the average vehicle speed of less than 20 km/h and a category of the average vehicle speed of equal to or greater than 20 km/h. However, for example, the drive information items may be alternatively classified by more levels, such as the first category of the average vehicle speed of less than 20 km/h, the second category of the average vehicle speed of equal to or greater than 20 km/h and less than 40 km/h, and the third category of equal to or greater than 40 km/h.

Also, in the above embodiments, it is described that the information center 3 receives the traffic flow information items, which are collected while the multiple probe vehicles travel, and stores the traffic flow information items in the database. However, the traffic flow information item stored in the database of the information center 3 is not necessarily collected while the probe vehicles travel.

Also, the above embodiments describe that the position confidence level is specified based on the precision information (for example, HDOP) included in the information that is received from the GPS sensor 11. the position confidence level indicates the precision of the present position of the target vehicle. However, for example, a map precision information item for each region is included in advance in the road map information of the map database, and thereby the position confidence level is specified in consideration of the above map precision information for each region.

Also, in the above embodiments, the collected drive information item is classified in accordance with the categories of the learning database. However, without making the learning database, the collected drive information items may be stored in the storage medium.

Note that, the correspondence between the present invention and the embodiments, the positioning portion 15a corresponds to position specifying means, S400 to S422 in FIG. 7 correspond to storage control means, S410, S418 correspond to statistical confidence level storage means, S412, S420 correspond to position confidence level storage means, and S300 correspond to learning database making means.

In the above embodiment, a first provisional statistical confidence level may be defined as a degree of variation of the collected drive information item from the predetermined reference value B. Also, a second provisional statistical confidence level may be defined as a degree of variation of a past drive information item from the predetermined reference value B and is stored in the storage medium 15c. Then, an average value is acquired based on the first and second provisional statistical confidence levels such that the average value is stored in the storage medium 15c as the new statistical confidence level. Thus, the on-board control device is enabled to recognize the degree of variation of the drive information items based on the statistical confidence level, and thereby is enabled to more accurately operate controls.

Also, in the above embodiment, a first provisional position confidence level may be acquired based on the collected drive information item. Also, a second provisional position confidence level may be acquired based on a past drive information item and is stored in the storage medium 15c. Then, an average value is acquired based on the first and second provisional position confidence levels such that the acquired average value is stored as the new position confidence level in the storage medium 15c. As a result, the on-board control device is enabled to recognize the precision of the present position based on the position confidence level, and thereby, is enabled to more accurately perform controls.

Additional advantages and modifications will readily occur to those skilled in the art. The invention in its broader terms is therefore not limited to the specific details, representative apparatus, and illustrative examples shown and described.

What is claimed is:

1. A drive information collecting apparatus for a vehicle comprising:
position specifying means for specifying a present position of the vehicle and a road section, on which the vehicle travels;
storage control means for causing a storage medium to store a drive information item of each of the road section, the drive information item being collected while the vehicle travels; and
statistical confidence level storage means for specifying a statistical confidence level based on a divergence between a predetermined reference value and the collected drive information item, the statistical confidence level indicating a degree of variation of the collected drive information item, the statistical confidence level storage means associating the collected drive information item with the statistical confidence level and causing the storage medium to store the collected drive information item.

2. The drive information collecting apparatus according to claim 1, wherein:
the statistical confidence level storage means acquires an average value based on the statistical confidence level of the collected drive information item and a statistical confidence level of a past drive information item stored in the storage medium; and
the statistical confidence level storage means causes the storage medium to store the acquired average value as a new statistical confidence level.

3. The drive information collecting apparatus according to claim 1 further comprising:
position confidence level storage means for specifying a position confidence level indicative of a precision of the present position of the vehicle, the position confidence level storage means associating the position confidence level with the collected drive information item, the position confidence level storage means causing the storage medium to store the position confidence level.

4. The drive information collecting apparatus according to claim 3, wherein:
the position confidence level storage means acquires an average value based on the position confidence level of the collected drive information item and a position confidence level of a past drive information item stored in the storage medium; and
the position confidence level storage means causes the storage medium to store the acquired average value as a new position confidence level.

5. The drive information collecting apparatus according to claim 1, further comprising:
learning database making means for making a learning database that has a plurality of categories of a time zone, the plurality of categories being made in accordance with a characteristic of a traffic flow information item stored in a database of an information center, the traffic flow information item indicating a traffic flow for the road section, wherein:
the storage control means updates the learning database using the collected drive information item.

6. The drive information collecting apparatus according to claim 5, wherein:
the storage control means acquires an average value based on the collected drive information item and a past drive information item stored in the storage medium; and
the storage control means updates the learning database using the acquired average value as a new drive information item.

7. The drive information collecting apparatus according to claim 1, wherein:
the drive information item includes at least one of a vehicle speed, an electric power consumption, a fuel consumption, gear shift lever position information, accelerator pedal position information, an engine rotational speed, a number of times of operating a brake, a road gradient, and a road degree of curve.

8. The drive information collecting apparatus according to claim 5, wherein:
the learning database making means causes the learning database to have additional categories of a day type, the additional categories being made in accordance with the characteristic of the traffic flow information item.

9. The drive information collecting apparatus according to claim 5, wherein:
the traffic flow information item is one of a plurality of traffic flow information items which are collected while a plurality of probe vehicles travel;
when the information center receives the plurality of traffic flow information items, the information center performs statistical processing to the received traffic flow information items and stores a result of the statistical processing in the database.

10. The drive information collecting apparatus according to claim 5, wherein:
the information center generates classification information that has the categories of the time zone in accordance with the characteristic of the traffic flow information item stored in the database; and
the learning database making means acquires the classification information from the information center for making the learning database in accordance with the classification information.

11. A drive information collecting apparatus for a vehicle comprising:
position specifying means for specifying a present position of the vehicle and a road section, on which the vehicle travels;
storage control means for causing a storage medium to store a drive information item of each of the road section, the drive information item being collected while the vehicle travels; and
statistical confidence level storage means for specifying a statistical confidence level based on a divergence between a predetermined reference value and the collected drive information item, the statistical confidence level storage means associating the collected drive information item with the statistical confidence level and causing the storage medium to store the collected drive information item.

12. The drive information collecting apparatus according to claim 11, wherein:
a first provisional statistical confidence level is a degree of variation of the collected drive information item from the predetermined reference value;
a second provisional statistical confidence level is a degree of variation of a past drive information item from the predetermined reference value and is stored in the storage medium;
the statistical confidence level storage means acquires an average value based on the first and second provisional statistical confidence levels; and
the statistical confidence level storage means causes the storage medium to store the acquired average value as the statistical confidence level.

13. The drive information collecting apparatus according to claim 11 further comprising:
position confidence level storage means for specifying a position confidence level indicative of a precision of the present position of the vehicle, the position confidence level storage means associating the position confidence level with the collected drive information item, the position confidence level storage means causing the storage medium to store the position confidence level.

14. The drive information collecting apparatus according to claim 13, wherein:
a first provisional position confidence level is acquired based on the collected drive information item;
a second provisional position confidence level is acquired based on a past drive information item and is stored in the storage medium;
the position confidence level storage means acquires an average value based on the first and second provisional position confidence levels; and
the position confidence level storage means causes the storage medium to store the acquired average value as the position confidence level.

15. The drive information collecting apparatus according to claim 11, wherein:
the statistical confidence level is acquired based on the collected drive information item and indicates a degree of variation of the collected drive information item from the predetermined reference value.

16. The drive information collecting apparatus according to claim 11, wherein:
the position confidence level is acquired based on the collected drive information item.

17. The drive information collecting apparatus according to claim 11, further comprising:
communication control means for communicating with an information center that has a database storing a traffic flow information item, the traffic flow information item indicating a traffic flow for the road section; and
learning database making means for acquiring the traffic flow information item through the communication control means to make a learning database that has a plurality of categories of a time zone, the plurality of categories being made in accordance with a characteristic of the traffic flow information item, wherein:
the storage control means updates the learning database using the collected drive information item.
